(19) United States
(12) Patent Application Publication
(10) Pub. No.: US 2025/0187095 A1
(43) Pub. Date: Jun. 12, 2025

(54) ADAPTIVE BATTERY POWER CONTROL DURING HYBRID POWERED WELDING

(71) Applicant: ESAB AB, Goteborg (SE)

(72) Inventors: Paramasivam Shanmugam, Chennai (IN); Mark Lowther, Warrington (GB); Govarthanan Rengamuni, Chennai (IN); Sankar Selvakumar, Chennai (IN)

(21) Appl. No.: 18/981,764

(22) Filed: Dec. 16, 2024

Related U.S. Application Data
(63) Continuation of application No. PCT/IB2023/056683, filed on Jun. 28, 2023.

(30) Foreign Application Priority Data
Jun. 29, 2022 (IN) 202241037355

(51) Int. Cl. B23K 9/10

(52) U.S. Cl. CPC B23K 9/1006

(57) ABSTRACT

A method of operating a hybrid power supply includes supplying to a power source, from a first energy source, power for a welding or a cutting process, selectively supplying to the power source, from a second energy source, supplementary power for the welding or the cutting process, and controlling an amount of the supplementary power that is supplied for the welding or the cutting process based on at least one of (a) a circuit breaker value of a circuit breaker arranged as a safety device in the first energy source (b) a voltage level presented by the first energy source, and (c) an output current setting of the power source.

### CLAIM TO PRIORITY

This application is a continuation of International (PCT) Patent Application No. PCT/IB2023/056683, filed Jun. 28, 2023, and entitled “ADAPTIVE BATTERY POWER CONTROL DURING HYBRID POWERED WELDING,” which claims priority to and is based on Indian Application No. 202241037355, filed Jun. 29, 2022, and entitled “ADAPTIVE BATTERY POWER CONTROL DURING HYBRID POWERED WELDING.” The entire disclosure of each of these applications is incorporated herein by reference.

### TECHNICAL FIELD

The subject disclosure relates to optimizing battery usage during battery/mains hybrid powered welding or cutting.

### BACKGROUND

A hybrid battery/mains-powered power source for a welding or cutting system generates power for a welding or cutting operation using power provided by batteries of a battery system and/or by power provided by an AC mains power supply system. The battery system may include a plurality of batteries connected in series and/or parallel and housed in a battery box or a caddy, where each individual battery may itself be a battery pack of several battery cells within a single battery housing. In some cases, the batteries used in a hybrid battery/mains-powered power source for a welding or cutting system may be the same as those that might be used with cordless power tools.

In conventional hybrid battery/mains-powered power sources, a fixed amount of power is drawn from the battery for meeting a desired hybrid boost power level. However, such a fixed amount of power drawn from the batteries may not be required in many instances, since available AC mains power may be sufficient to derive the desired overall power output of the system. Thus, in conventional hybrid systems, the power of the battery may discharge unnecessarily, resulting in shortened battery life. In other words, the conventional battery utilization approach in a hybrid battery/mains-powered power source does not optimally conserve battery energy.

### BRIEF DESCRIPTION OF THE DRAWINGS

FIG. 1 is a high-level block diagram of an example hybrid-powered (HP) power source configured to derive output power for a welding or cutting operation from one or both of AC mains input power and battery power provided by a battery system, according to an embodiment.

FIG. 2 shows another block diagram of the HP power source including several control signals shared between and among components of the HP power source, according to an embodiment.

FIGS. 3A and 3B depict a flowchart of a series of operations of a battery adaptive control process, according to an embodiment.

FIGS. 4A-4C are tables used to estimate a duty cycle of the HP power source for use in a battery adaptive control process, according to an embodiment.

FIG. 5 is a flowchart depicting another series of operations of a battery adaptive control process, according to an embodiment.

### DETAILED DESCRIPTION

As will be explained in more detail below, the HP power source described herein operates in hybrid boost mode in which both AC mains power and DC battery power may contribute to the output power (for welding or cutting). During hybrid boost mode, the energy drawn from the battery supply is optimized in view of the amount of available AC power. In some welding modes and in some circumstances, only AC mains power is used. In other welding modes and circumstances, only battery power is used, and in still other welding modes and circumstances, a hybrid approach is taken whereby both AC mains power and battery power is used, and where the use of battery power is optimized in an effort to conserve battery energy.

As will be explained in detail below, a method may be provided including operations of supplying to a power source, from a first energy source (e.g., AC mains), power for a welding or a cutting process, selectively supplying to the power source, from a second energy source (e.g., a battery or battery system), supplementary power for the welding or the cutting process, and controlling an amount of the supplementary power that is supplied for the welding or the cutting process based on at least one of (a) a circuit breaker value of a circuit breaker arranged as a safety device in the first energy source, (b) a voltage level presented by the first energy source, and (c) an output current setting of the power source.

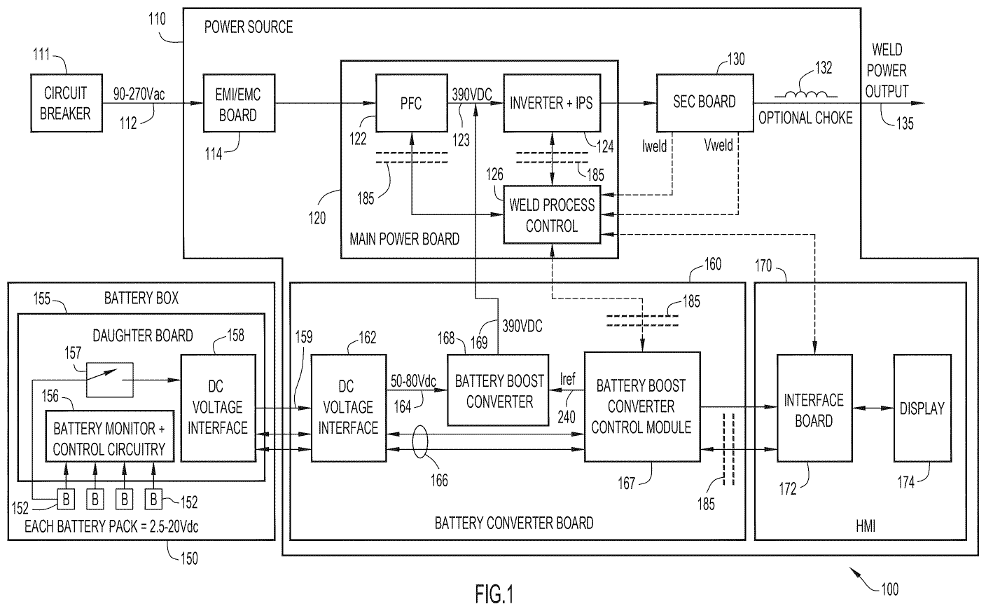

FIG. 1 is a high-level block diagram of an example HP power source 100 configured to derive output power for a welding or cutting operation from one or both of AC mains input power and battery power provided by a battery system, according to an embodiment. As shown in FIG. 1, HP power source 100 includes a power source 110 and a battery box 150 that may operate, in a hybrid mode, in concert with one another to generate a final weld power output 135 (or cutting power output). More specifically, power source 110 receives, via a safety device such as, e.g., circuit breaker 111, an AC mains voltage 112, which can be anywhere from 90-270 VAC. AC mains voltage 112 is supplied to an optional electromagnetic interference/electromagnetic interference (EMI/EMC) board 114. An output of EMI/EMC board 114, if used, is fed to a main power board 120, which includes a power factor correction (PFC)/rectifier 122, which rectifies the AC mains voltage 112 and boosts and regulates that voltage to a constant voltage on DC link 123 of, e.g., 390 volts DC. The voltage on DC link 123 is fed to an inverter 124 (and, optionally, to an internal power supply (IPS)), which outputs welding (or cutting) power in response to control signals received from weld process control 126. Weld process control 126 may receive various inputs including an indication of the voltage on DC link 123, Output Current (Iₒᵤₜ) and Output Voltage (Vₒᵤₜ), as well as user-selected information such as the weld process (e.g., MMA, TIG, MIG, etc.), and related parameters, from a human-machine interface (HMI) 170.

A secondary board 130 may be disposed between an output of inverter 124 and weld power output 135 and may include, among other things, a high-frequency transformer and a secondary rectifier (not shown). Secondary board 130 may supply the Output Current (Iₒᵤₜ) and Output Voltage (Vₒᵤₜ) signals, and may further feed an optional choke 132 (i.e., an output inductor) disposed prior to the weld power output 135.

HMI 170 may comprise an interface board 172 that may include one or more push buttons, encoders, or switches, as well as, e.g., a USB interface, among other possible input/output devices. Interface board 172 is in communication with, e.g., a display 174, which may also include touch control. Communication between interface board 172 and display 174 may be implemented using a universal synchronous/asynchronous receiver/transmitter (USART), or any other suitable communications interface.

Still with reference to FIG. 1, HP power source 100 includes battery box 150, which includes a plurality of batteries 152, which may be connected in series with one another, a daughter board 155, which may host battery monitor and control circuitry 156, and a switch 157 configured to connect battery power to a DC voltage interface 158. Batteries 152 may be rechargeable, either within battery box 150, or separately.

DC voltage interface 158 is connected to battery converter board 160 via DC voltage interface 162 over connection 159, and supplies battery power 164 (e.g., 50-80 VDC) to battery boost converter 168, which is under the control of battery boost converter control module 167. Battery boost converter 168 is configured to output to DC link 123 a preferred voltage, such as 390 volts DC to match the output of PFC rectifier 122. Battery boost converter control module 167 monitors, among other things, information supplied to interface board 172, as well as information regarding battery health and voltage via communications link 166, which may be operated as a link consistent with, e.g., a controller area network (CAN) and/or with other analog and/or digital links.

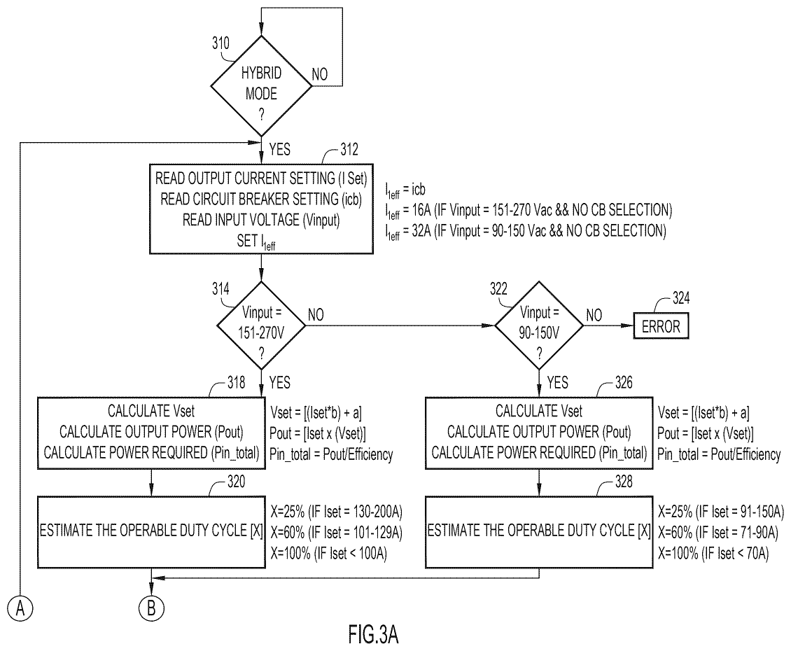

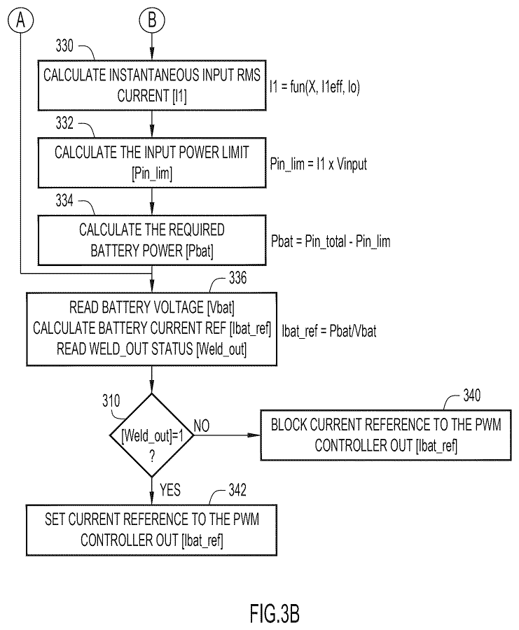

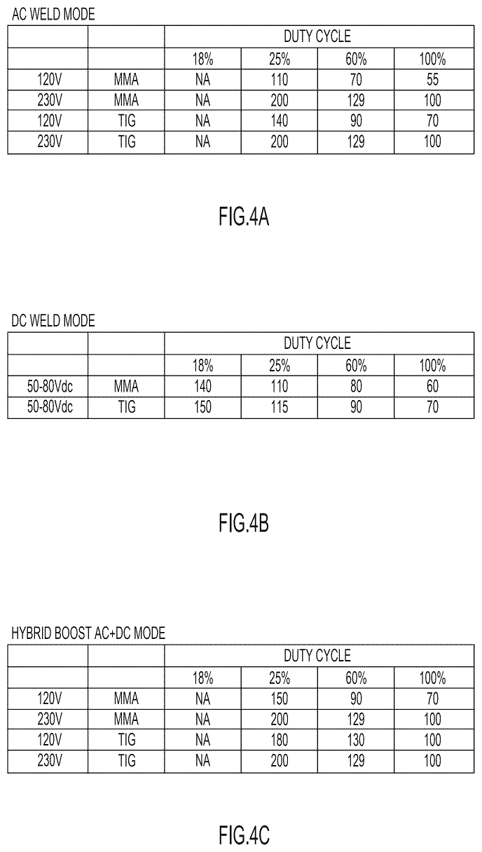

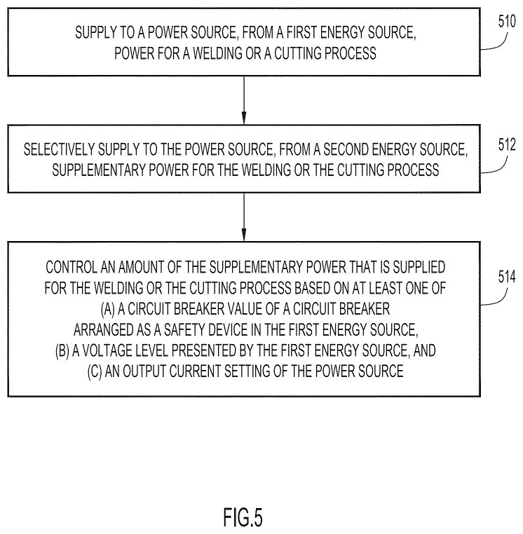

Thus, as shown in FIG. 1, HP power source 100 comprises boost converters on the AC side (PFC rectifier 122) and battery side (battery boost converter 168), which fix the voltage of DC link 123 to, e.g., 390 volts DC, or any desired predetermined voltage. During hybrid boost mode, power sharing from the battery side is determined and set based on a current reference (I_{ref} or I_{bat_ref}) generated by battery boost converter control module 167 and sent to the battery boost converter 168. Current reference value (I_{ref} or I_{bat_ref}) is determined based on several parameter measurements, as discussed in more detail with reference to FIGS. 3 and 4.

In some embodiments, reinforced isolation 185 between selected components may be implemented to increase safety by isolating higher voltage signals from coming into contact with a user.

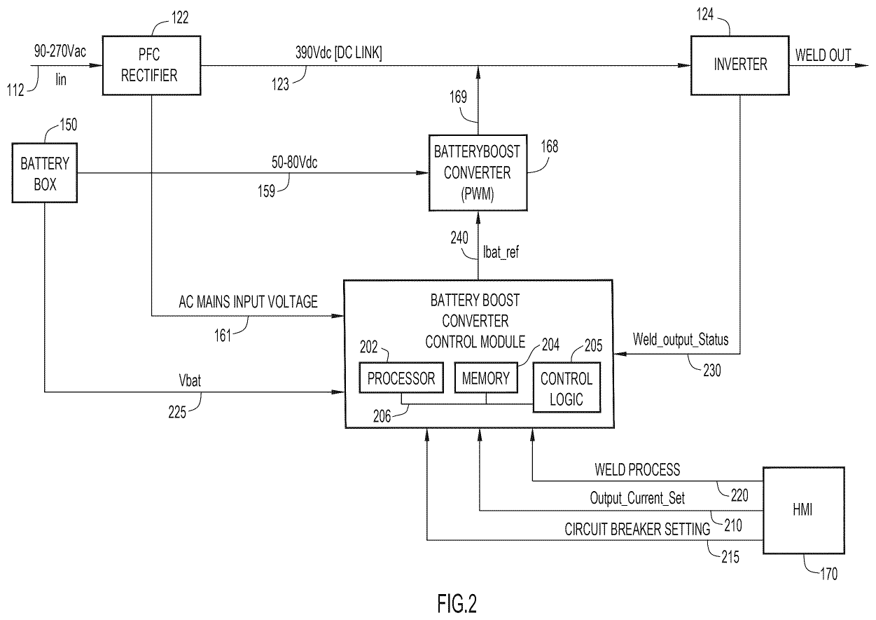

FIG. 2 shows control signals shared between and among several components of the HP power source 100, according to an embodiment. As shown in the figure, battery box 150 supplies 50-80 volts DC (based on how many batteries 152 are connected in series) via connection 159, and an indication of battery voltage (Vₕₐₜ) 225 to battery boost converter control module 167. PFC rectifier 122 supplies an indication of AC mains input voltage 161 to battery boost converter control module 167. That indication may pass through weld process control 126 as suggested by FIG. 1. HMI 170 provides, e.g., three pieces of information (via appropriate electrical signals) to battery boost converter control module 167: an output current setting 210, a circuit breaker setting 215, and a selected weld or cutting process 220. This information may have been entered via HMI 170 by a user. Inverter 124 provides a weld output status 230 to battery boost converter control module 167.

With the signals and information provided to battery boost converter control module 167 by the several components shown in FIG. 2, battery boost converter control module 167 generates the signal I_{bat_ref} 240 (or I_{ref}), which is supplied to battery boost converter 168 to control how much energy from battery box 150 is to be delivered to the DC link 123. That ref 240 is determined, as will be explained in detail below, using an adaptive battery power control process that is configured to:
(1) Optimally control the battery power output during hybrid mode considering the status of different parameters to avoid nuisance tripping of a mains circuit breaker/fuse, when the current exceeds permissible limits. For example, in a 230V grid, 16A is the limited current as 16A rated fuses and circuit breakers are common;
(2) Regulate the AC mains input current to a limit (based on a programmed circuit breaker setting from HMI 170) by injecting battery boost power; and
(3) Deliver higher power output during hybrid boost mode based on duty cycle levels of HP power source 100 as shown in FIGS. 4A-4C, and as will be explained in connection with FIG. 3.

Battery boost converter control module 167 may be configured as a computing device including one or more processors 202, and memory 204 that may be configured to store control logic 205 and perform the techniques described herein, according to an example embodiment.

Processor(s) 202 is/are at least one hardware processor configured to execute various tasks, operations and/or functions as described herein according to software and/or instructions. Processor(s) 202 (e.g., a hardware processor) can execute any type of instructions associated with data to achieve the operations detailed herein. In one example, processor(s) 202 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

Memory 204 is configured to store data, information, software, and/or instructions (e.g., control logic 205 consistent with, e.g., FIG. 3). Memory 204 may be implemented as any one or more of suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate.

A bus 206 can be configured to interconnect processors(s) 202, memory 204 and control logic 205, and enable those elements to communicate in order to exchange information and/or data. Bus 206 can be implemented with any architecture designed for passing control, data and/or information between processors, memory elements/storage, peripheral devices, and/or any other hardware and/or software components.

In various embodiments, control logic 205 can include instructions that, when executed, cause processor(s) 202 to perform operations, which can include, but not be limited to, providing overall control operations; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 205) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory 204 can store data, software, code, instructions (e.g., processor instructions), logic, parameters, combinations thereof, and/or the like used for operations described herein. This includes memory 204 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

The adaptive battery power control according to the disclosed embodiments operates in view of the following factors and parameters:
(1) AC mains voltage 112 (measurement from AC Grid);
(2) State of Charge, e.g., collectively, of the batteries 152 (measurement from batteries, Vbat 225);
(3) Rating of the AC mains circuit breaker being used (Circuit breaker setting 215, programmed via HMI 170); and
(4) Output Power (calculated using output current setting 210 from HMI 170).

As discussed with reference to FIG. 2, the battery boost converter control module 167 senses or is supplied various parameters, including:
(1) AC mains voltage 112 (measurement from AC Grid);
(2) Output current setting 210 (the demanded weld output current programmed via HMI 170);
(3) Circuit breaker setting 215 (the upstream installed circuit breaker rating entered via HMI 170);
(4) Weld output status 230 (i.e., an indication of output power on/off obtained from, e.g., inverter 124);
(5) Battery voltage Vbat 225; and
(6) Weld (or cutting) process 220.

In one embodiment, the adaptive battery power control process operates in accordance with the series of steps shown in FIGS. 3A and 3B, and reference is now made to those figures.

The general approach to is calculate appropriate PWM control in battery boost converter 168 that will allow a desired amount of supplemental power to flow from batteries 152 to DC link 123 to assist in providing welding or cutting power, and/or help to avoid undesirable AC mains circuit breaker operation, given the amount of power available from the AC mains and the desired welding or cutting power.

More specifically, at 310, it is determined whether the system is in hybrid mode. That is, it is determined whether that mode has been selected, e.g., via an option on HMI 170 or automatically entered as a result of decision logic of battery boost converter control module 167 or some other component of the HP power source 100. If hybrid mode is enabled, then at 312, an operation determines what current, I_{leff}, is needed from the grid, i.e., AC mains. This determination is made based on several possible inputs including the output current setting 210 (Iₛₑₜ) and/or the circuit breaker setting 215 (I_{cb}) read from HMI 170, and the AC mains input voltage 161 (Vᵢₙₚᵤₜ). If no circuit breaker option is selected in HMI 170, the following automatic setting functions may be performed.

(1) If the AC mains input voltage 161 is in the range of 151-270 VAC, then the system may be configured to limit the maximum effective supply RMS current (I_{leff}) to below 16A.

(2) If the AC mains input voltage 161 is in the range of 90-150 VAC, then the system may be configured to limit the maximum effective supply RMS current (I_{leff}) to below 32A.

If the circuit breaker setting 215 is input via HMI 170, the limit may be set according to the circuit breaker set rating. The ultimate goal is to limit the maximum effective supply RMS current (I_{leff}) below the circuit breaker set rating, either explicitly using the circuit breaker setting 215, or implicitly using AC mains input voltage 161.

Once the input current limit (I_{leff}) is set at operation 312, and the desired output current setting 210 (Iₛₑₜ) is obtained via HMI 170, a value Vₛₑₜ is calculated based on the Iₛₑₜ value.

Specifically, at operation 314, it is determined whether the AC mains input voltage is 151-270V. If yes, then at 318,

Vₛₑₜ is calculated according to Vₛₑₜ=[(Iₛₑₜ*b)+a];

Output power (Pₒᵤₜ) is calculated according to Pₒᵤₜ=[Iₛₑₜ*(Vₛₑₜ)]; and

Required power (P_{in_total}) is calculated as Pₒᵤₜ/Efficiency

Example values of the indicated variables “a” and “b” are illustrated in the table below for different weld processes (where a given weld process is indicated by weld or cutting process 220). The Efficiency value is a predetermined value.

For Weld applications

| | Less than 600A | | Greater than 600A | |
|---|---|---|---|---|
| Output Current (Iset) | a | b | a | b |
| MMA | 20 | 0.04 | 44 | 0 |
| MIG/TIG | 14 | 0.04 | 44 | 0 |
| TIG | 10 | 0.05 | 44 | 0 |

For Plasma Cutting applications

| | Less than 170A | | 170A< and >500A | | Above 500A | |
|---|---|---|---|---|---|---|
| Output Current (Iset) | a | b | a | b | a | b |
| Plasma Cutting | 80 | 0.4 | 131 | 0.1 | 181 | 0 |

With Vₛₑₜ calculated, the required output power may also be calculated. By knowing the weld process from HMI 170, and still at operation 318, the system can then also estimate the required input power (P_{in_total}).

Specifically, based on a known estimated efficiency (i.e., a constant, e.g., 80%) and the weld output power, the total input power (P_{in_total}) requirement can be calculated by the system according to P_{in_total}=Pₒᵤₜ/Efficiency.

At operation 320, an operable duty cycle X is estimated. The duty cycle X nominally represents a percentage of time that welding can be performed in a given ten-minute period at a given input voltage and desired current level Iₛₑₜ. For example, in a welding operation relying solely on AC mains input power at 120 VAC, for an MMA weld process at 110 amps, the duty cycle X is 25% (2.5 minutes of welding time in a ten-minute period). As the desired welding current setting Iₛₑₜ is reduced, the duty cycle can increase. Note that, in some instances (e.g., with a 120 VAC input), for a given duty cycle, AC input voltage, and weld process, a higher current level can be maintained by using the hybrid boost mode (both AC input power and battery power) relative to using only AC input power. Stated differently, for a given welding current setting Iₛₑₜ, a higher duty cycle may be maintained for a selected weld process in hybrid boost mode than in an AC input mode (without battery boost).

As indicated, duty cycle X=25% if Iₛₑₜ=130−200A, duty cycle X=60% if Iₛₑₜ=101−129A, and duty cycle X=100% if Iₛₑₜ<100A.

Returning to operation 314 in FIG. 3, if AC mains input voltage 161 is not 151-270V, then operation 322 is executed to determine if AC mains input voltage 161 is 90-150V. If not, then an error may be indicated at 324, as perhaps the power supply is not connected to mains power. On the other hand, if operation 322 results in a yes, then operations 326 and 328 are executed. Operation 326 is similar to operation 318, and operation 328 is similar to operation 320, except for the ranges of Iₛₑₜ corresponding to the duty cycle X values. For operation 328, duty cycle X=25% if Iₛₑₜ=91-150A, duty cycle X=60% if Iₛₑₜ=71-90A, and duty cycle X=100% if Iₛₑₜ<70A.

Whether the path of operations 318 and 320, or the path of operations 326 and 328, are taken, both end up at operation 330.

At operation 330, an instantaneous input RMS current (I₁) is calculated. I₁ may be derived from the maximum effective supply RMS current (I_{leff}) using the following formula knowing the allowable duty cycle X.

$${I}_{1} = \frac{{I}_{1 eff} - {I}_{0} \sqrt{1 - X}}{\sqrt{X}} Where {I}_{0} = No load input current$$

The duty cycle X may be obtained, as indicated above, from the tables shown in FIGS. 4A-C given the available voltage, Iₛₑₜ, and weld process (e.g., MMA, TIG). Note that the values in the table of FIG. 4 represent just one non-limiting example of possible duty cycle values for a set of voltage and current levels.

After calculating the instantaneous input RMS current (I₁), that value may be used, in operation 332, to calculate the instantaneous input power limit (P_{in_lim}) from the AC mains knowing the AC mains input voltage 161 (Vᵢₙₚᵤₜ), i.e., P_{in_lim}=I1*Vᵢₙₚᵤₜ.

Then, at operation 334, using the calculated instantaneous input power limit (P_{in_lim}), the difference between total input power (P_{in_total}) and the instantaneous input power limit (P_{in_lim}) is calculated to indicate the battery power (P_{bat}) required to be added to power delivered via the AC mains. Here, P_{bat}=P_{in_total}−P_{in_lim}.

Then, at operation 336, a battery current reference value (I_{bat_ref}) is calculated. This value is the amount of current needed from the batteries 152. Here, I_{bat_ref}=P_{bat}/V_{bat}. Vbat 225 is shown in FIG. 1, for example. Also at operation 336, the weld output status 230 is read.

At operation 338, if welding power is not being output according to weld output status 230, then at 340, the battery current reference value (I_{bat_ref}) 240 is not supplied to battery boost converter 168, or is set to zero such that no power flows from the batteries 152.

On the other hand, if at operation 338 welding power is being output according to weld output status 230, then at 342, battery current reference value (I^{bat_ref}) 240 is supplied to battery boost converter 168 such that power from the batteries 152 is boosted in voltage and applied via a pulse wave modulation scheme in an appropriate amount to supplement current provided via DC link 123, and thus available at weld power output 135.

That is, the battery current reference value (I^{bat_ref}) 240 is supplied to a PWM controller of battery boost converter 168 to regulate battery boost converter 168 (see FIG. 2). In an embodiment, the battery current reference value (I^{bat_ref}) 240 is gated only when there is a weld output detected.

FIG. 5 is a flowchart depicting another series of operations for a battery adaptive control process, according to an embodiment. At 510, an operation includes supplying to a power source, from a first energy source, power for a welding or a cutting process. At 512, an operation includes selectively supplying to the power source, from a second energy source, supplementary power for the welding or the cutting process. And, at 514, an operation includes controlling an amount of the supplementary power that is supplied for the welding or the cutting process based on at least one of (a) a circuit breaker value of a circuit breaker arranged as a safety device in the first energy source, (b) a voltage level presented by the first energy source, and (c) an output current setting of the power source.

Assuming battery energy is available and has been selected as an option via HMI 170, hybrid boost power is made available:
when the AC input current limit is set by the circuit breaker,
when the input current limit is 16A (in, e.g., European mains), or
when the extended output current is demanded with the support of battery power.

Notably, in the methodology described herein, no thermal measurement is needed within the HP power source 100 to control the battery power.

For convenience, the several variables and parameters described above in connection with the adaptive battery power control process are summarized below.

| | |
|---|---|
| Iₛₑₜ | The target/desired weld current set at the HMI |
| I_{cb} | Circuit breaker setting (16A or 32A, set at the HMI) |
| Vᵢₙₚᵤₜ | AC mains input voltage |
| Vₛₑₜ | A calculated voltage value based on Iₛₑₜ and predetermined |
| | constants used to calculate desired output power (Pₒᵤₜ) |
| I_{1eff} | Maximum effective supply RMS current - set at the HMI (16A |
| | or 32A) as I_{cb} or automatically set based on AC input |
| | voltage level |
| Pₒᵤₜ | Required weld output current based on Iₛₑₜ and Vₛₑₜ |
| Pᵢₙ_{_{—}}ₜₒₜₐₗ | Total Input Power needed given the inefficiency in the power |
| | supply |
| X | Inverter duty cycle - obtained from a predetermined table |
| I₀ | No load input current, i.e., idle current |
| I₁ | Instantaneous input RMS current - computed from I_{1eff}, I₀, |
| | and X via equation |
| Pᵢₙ₋ₗᵢₘ | Instantaneous input power limit from the AC mains - computed |
| | from I₁ × Vᵢₙₚᵤₜ |
| P_{bat} | Battery power required: Pᵢₙ_{_{—}}ₜₒₜₐₗ − Pᵢₙ_{_{—}}ₗᵢₘ |
| V_{bat} | Battery voltage - total voltage of batteries |
| I_{bat-ref} | Required battery current (P_{bat}/V_{bat}) - used by PWM controller |
| | to regulate battery boost converter |

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’ (s)′ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
supplying to a power source, from a first energy source, power for a welding or a cutting process;
selectively supplying to the power source, from a second energy source, supplementary power for the welding or the cutting process; and
controlling an amount of the supplementary power that is supplied for the welding or the cutting process based on at least one of (a) a circuit breaker value of a circuit breaker arranged as a safety device in the first energy source, (b) a voltage level presented by the first energy source, and (c) an output current setting of the power source.

2. The method of claim 1, wherein the first energy source comprises mains power.

3. The method of claim 1, wherein the second energy source comprises a battery.

4. The method of claim 1, further comprising controlling the amount of the supplementary power that is supplied for the welding or the cutting process based on an expected duty cycle of the power source.

5. The method of claim 1, further comprising controlling the amount of the supplementary power that is supplied for the welding or the cutting process based on a voltage presented by the second energy source.

6. The method of claim 1, further comprising selectively supplying to the power source, from the second energy source, supplementary power for the welding or the cutting process based on whether the power source is actively delivering power for the welding or the cutting process.

7. The method of claim 1, further comprising controlling the amount of the supplementary power that is supplied for the welding or the cutting process using pulse wave modulation (PWM).

8. The method of claim 1, further comprising receiving an indication of the circuit breaker value via a human machine interface.

9. The method of claim 1, further comprising receiving an indication of the output current setting of the power source via a human machine interface.

10. The method of claim 1, further comprising selectively supplying the supplementary power for the welding or the cutting process to a DC link that feeds an inverter of the power supply.

11. A power source, comprising:
a rectifier;
an inverter, connected to the rectifier via a DC link;
a battery;
a battery boost converter arranged to receive power from the battery; and
a battery boost converter controller in communication with the battery boost converter and configured to control the battery boost converter to supply supplementary power from the battery to the DC link based on at least one of (a) a circuit breaker value of a circuit breaker arranged as a safety device in an circuit that feeds power to the rectifier, (b) a voltage level presented by the circuit that feeds power to the rectifier, and (c) an output current setting of the power source.

12. The power source of claim 11, configured to supply welding power or cutting power.

13. The power source of claim 11, wherein the circuit that feeds power to the rectifier comprises mains power.

14. The power source of claim 11, wherein the battery boost converter controller is configured to control an amount of the supplementary power based on an expected duty cycle of the power source.

15. The power source of claim 11, wherein the battery boost converter controller is configured to control an amount of the supplementary power based on a voltage presented by the battery.

16. The power source of claim 11, wherein the battery boost converter controller is configured to control an amount of the supplementary power based on whether the power source is delivering power for a welding or a cutting process.

17. The power source of claim 11, wherein the battery boost converter comprises a pulse wave modulation (PWM) to control an amount of the supplementary power that is supplied to the DC link.

18. One or more non-transitory computer readable storage media encoded with instructions that, when executed by a processor, cause the processor to:
supply to a power source, from a first energy source, power for a welding or a cutting process;
selectively supply to the power source, from a second energy source, supplementary power for the welding or the cutting process; and
control an amount of the supplementary power that is supplied for the welding or the cutting process based on at least one of (a) a circuit breaker value of a circuit breaker arranged as a safety device in the first energy source, (b) a voltage level presented by the first energy source, and (c) an output current setting of the power source.

19. The one or more non-transitory computer readable storage media of claim 18, wherein the instructions, when executed by the processor, are configured to control the amount of the supplementary power that is supplied for the welding or the cutting process based on an expected duty cycle of the power source.

20. The one or more non-transitory computer readable storage media of claim 18, wherein the instructions, when executed by the processor, are configured to control the amount of the supplementary power that is supplied for the welding or the cutting process using pulse wave modulation (PWM).
